(19) United States
(12) Patent Application Publication
(10) Pub. No.: US 2022/0404753 A1
(43) Pub. Date: Dec. 22, 2022

(54) DETERMINING PRINT OFFSET

(71) Applicant: Hewlett-Packard Development Company, L.P., Spring, TX (US)

(72) Inventors: Maty Verner, Ness Ziona (IL); Oleg Kishtov, Ness Ziona (IL); Lior Joseph, Ness Ziona (IL)

(73) Assignee: Hewlett-Packard Development Company, L.P., Spring, TX (US)

(21) Appl. No.: 17/777,604

(22) PCT Filed: Nov. 18, 2019
(86) PCT No.: PCT/US2019/062029

§ 371 Date: May 17, 2022

(51) Int. Cl. G03G 15/00; G03G 15/10

(52) U.S. Cl. CPC G03G 15/5033; G03G 15/104; G03G 15/55; G03G 2221/1654

(57) ABSTRACT

Disclosed is a print offset determining apparatus. The apparatus is to receive information indicative of a position of an imaging element relative to a binary ink developer when the binary ink developer comes into contact with the imaging element and determine an offset between the position of the imaging element and a reference position of the imaging element relative to the binary ink developer.

### BACKGROUND

Liquid electrophotographic printing uses liquid ink to form images on a print medium. A liquid electrophotographic printer may use digitally controlled lasers to create a latent image in the charged surface of an imaging element, such as a photo imaging plate (PIP). In this process, a uniform static electric charge is applied to the PIP and the lasers dissipate charge in certain areas creating the latent image in the form of an invisible electrostatic charge pattern conforming to the image to be printed. An electrically charged printing substance, in the form of liquid ink, is then applied and attracted to the partially-charged surface of the PIP, recreating the desired image.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic diagram of an example printer.

FIG. 2 is a schematic diagram of an example binary ink developer and an example imaging element.

FIG. 3 is a flow diagram of an example method.

FIG. 4 is a schematic diagram of an example non-transitory computer-readable medium.

### DETAILED DESCRIPTION

In the following description, for purposes of explanation, numerous specific details are set forth in order to provide a thorough understanding of the present systems and methods. It will be apparent, however, that the present apparatus, systems and methods may be practiced without these specific details. Reference in the specification to “an example” or similar language means that a particular feature, structure, or characteristic described in connection with the example is included in at least that one example, but not necessarily in other examples.

In certain liquid electrophotographic printers, a transfer element is used to transfer developed liquid ink to a print medium. For example, a developed image, comprising liquid ink aligned according to a latent image, may be transferred from a PIP to a transfer blanket of a transfer cylinder and from the transfer blanket to a desired substrate, which is placed into contact with the transfer blanket. At least two different methodologies may be used to print multi-color images on a liquid electrophotographic printer. Both methodologies involve the generation of multiple separations, where each separation is a single-color partial image. When these separations are superimposed it can result in the desired full color image being formed. In a first methodology, a color separation layer is generated on the PIP, transferred to the transfer cylinder and is finally transferred to a substrate. Subsequent color separation layers are similarly formed and are successively transferred to the substrate on top of the previous layer(s). This is sometimes known as a “multi-shot color” imaging sequence. In a second methodology, a “one shot color” process is used. In these systems, the PIP transfers a succession of separations to the transfer blanket on the transfer cylinder, building up each separation layer on the blanket. Once some number of separations are formed on the transfer blanket, they are all transferred to the substrate together. Both methodologies result in a full color image being formed.

In some electrophotographic printers, a binary ink developer (BID) comprises the liquid ink which is transferred to the PIP. The liquid ink comprises ink particles and a carrier liquid. More than one BID can be used, each BID comprising different colour ink. The ink or pigment particles are charged and may be arranged upon the PIP based on a charge pattern of a latent image. Once liquid ink is applied to the latent image on the PIP, an inked image is formed on the PIP. The inked image comprises ink particles that are aligned according to the latent image.

An example printer comprises an imaging element, such as a PIP. The imaging element may be implemented as a drum or a belt, for example. A latent image is generated on the imaging element and at least one binary ink developer (BID) deposits a layer of liquid ink onto the imaging element. Once liquid ink is applied to the latent image on the imaging element, an inked image is formed on the imaging element. The inked image comprises ink particles that are aligned according to the latent image. A transfer element, sometimes referred to as an intermediate transfer member, receives the inked image from the imaging element and transfers the inked image to a print substrate. In an example one shot color process, the inked image comprises one of a plurality of separation layers and the transfer element receives multiple separation layers of inked images from the imaging element. The layers are then built up upon the transfer element prior to transferring all of the layers to the print substrate. In some examples, each of the multiple inked images are a different color.

In an example, the BID and the imaging element can be engaged and disengaged by changing a distance between the BID and the imaging element. In the engaged position, liquid ink is transferrable from the BID to the imaging element. In order to maintain the accuracy of individual prints, there is a need to ensure that the movement of the BID is correctly synchronized with the imaging element, such that the BID contacts the imaging element at the correct point on the imaging element. Moreover, correctly synchronizing movement of the BID with the imaging element may avoid the BID coming into contact with undesirable areas of the imaging element (for example a seam area of the imaging element). Methods of synchronizing the BID and the imaging element may use of excess print materials which can be wasteful and time consuming.

FIG. 1 shows a schematic view of a printer 1 (for example an electrophotographic printer) comprising a system 2 according to one example. Liquid electrophotography, sometimes also known as Digital Offset Color printing, is a process of printing in which liquid ink is applied onto a surface having a pattern of electrostatic charge (i.e. a latent image) to form a pattern of liquid ink corresponding with the electrostatic charge pattern (i.e. an inked image). This pattern of liquid ink is then transferred to at least one intermediate surface, and then to a print medium.

According to the example of FIG. 1, during operation of the printer 1 a latent image is formed on an imaging element 3 by rotating a clean, bare segment of the imaging element 3 under a photo charging unit 10. The imaging element 3 in this example is cylindrical in shape, e.g. is constructed in the form of a drum, and is to rotate in a direction of arrow 11. Alternatively, the imaging element 3 may be substantially planar and/or may take the form of a belt. In one example, the imaging element 3 is a photo imaging plate (PIP).

A uniform static charge may be deposited on the imaging element 3 by the photo charging unit 10. As the imaging element 3 continues to rotate, it passes an imaging unit 12 where laser beams may dissipate localized charge in selected portions of the imaging element 3 to leave an invisible electrostatic charge pattern that corresponds to the image to be printed, i.e. a latent image. In some implementations, the photo charging unit 10 applies a negative charge to the surface of the imaging element 3. In other implementations, the charge may be a positive charge. The imaging unit 12 may locally discharge portions of the imaging element 3, resulting in local neutralized regions on the imaging element 3.

In example printers, ink is transferred onto the imaging element 3 by one or more BIDs 4. The printer may be for printing using inks of the colors cyan, magenta, yellow and black. There may be one or more BIDs 4 for each ink color. In the example of FIG. 1, two BIDs are shown. However, fewer or more BIDs 4 may be utilized. For example, the system 2 may comprise one, two, three, four, five, six, seven, eight, nine or ten BIDs. During printing, a BID 4 comes into contact with the imaging element 3. The BID 4 presents a uniform film of ink to the imaging element 3. The ink contains electrically-charged pigment particles which are repelled by the charged areas of the imaging element 3 and attracted to the areas of imaging element 3 where the laser beams have dissipated charge (i.e. attracted to the latent image). The imaging element 3 now has a single-color ink image on its surface, i.e. an inked image or separation. In other examples, other mechanisms, such as alternative charging and discharging regimes, may be used to control which areas of the imaging element 3 the electrically-charged particles are attracted to.

The imaging element 3 continues to rotate and transfers the ink image to a transfer element 7, which may be heatable. The transfer element 7 rotates in a direction of arrow 13. The transfer of the inked image from the imaging element 3 to the transfer element 7 may be deemed the “first transfer”. Following the transfer of the inked image onto the rotating transfer element 7, the ink is heated by the transfer element 7. In certain implementations, the ink may also, or alternatively, be heated from an external heat source which may include an air supply. This heating causes the ink particles to partially melt and blend together. As previously discussed, in liquid electrophotography printers employing a one shot color process, the imaging element 3 rotates several times, transferring a succession of separations and building them up on the transfer element 7 before they are transferred to the print substrate 14. This transfer from the transfer element 7 to the print substrate 14 may be deemed the “second transfer”. Each separation may be a separate color inked image that can be layered on the transfer element 7. For example, there may be four layers, corresponding to the standard CMYK colors (cyan, magenta, yellow and black), that make up the final image which is transferred to the print substrate 14. In such examples there would be at least four BIDs 4. The print substrate 14 may be fed on a per-sheet basis, or from a roll sometimes referred to as a web substrate. As the print substrate 14 contacts the transfer element 7, the final image is transferred to the print substrate 14.

In the example of FIG. 1, a driver 5 is operatively connected to the BID 4 to drive the BID 4 relative to the imaging element 3. The driver 5 is to drive the BID 4 towards the imaging element 3 such that the BID 4 comes into contact with the imaging element 3. In one example, the driver 5 is a servo motor. Alternatively, the driver 5 may be any device capable of driving the BID 4 relative to the imaging element 3. When more than one BID 4 is provided, there may be a plurality of such drivers 5 for driving the respective BIDs 4 relative to the imaging element 3.

The driver 5 may be directly connected to the BID 4, as shown in FIG. 1. Alternatively, the driver 5 may be indirectly connected to the BID 4. For example, the driver 5 may be connected to the BID 4 by a mechanical linkage.

The system 2 of FIG. 1 also comprises a controller 6. The controller 6 is to determine information indicative of a position of the imaging element 3 relative to the BID 4 when the BID 4 comes into contact with the imaging element 3. The information indicative of the position of the imaging element may comprise information indicative of an angular position of the imaging element 3 relative to the BID 4 when the imaging element 3 is a drum or otherwise mounted for rotational movement relative to the BID 4.

In one example, the controller 6 may be to determine that the BID 4 has come into contact with the imaging element 3 by determining a change in a property of the driver 5. For example, the property of the driver 5 may be an electrical current. The controller 6 may determine that there has been a sufficient change in the current of the driver 5 to indicate that the BID 4 has come into contact with the imaging element 3. Alternatively, the controller 6 may determine that the current has exceeded a predetermined threshold current which is indicative of the BID 4 coming into contact with the imaging element 3. In one example, the property of the driver may be a torque. The torque may be directly measured at the driver 5 or may be determined on the basis of another property of the driver 5 (e.g. the electrical current).

The controller 6 shown in FIG. 1 also is to determine a correction factor for use in subsequent driving of the BID 4 relative to the imaging element 3, such as towards the imaging element 3. The correction factor is based on the position of the imaging element 3 indicated by the information, and a reference position of the imaging element 3 relative to the BID 4. The correction factor is to be used in the subsequent driving of the BID 4, in order to help synchronize the movement of the BID 4 relative to the imaging element 3. For example, the correction factor may be used to help ensure that the BID 4 subsequently comes into contact with the imaging element 3 at a predetermined contact point 17 on the imaging element 3. This process of synchronization does not need to use any print materials (i.e. ink or substrate) and can be carried out relatively quickly. In one example, the process may be automated such that no human intervention is necessary.

As discussed above, in the example shown in FIG. 1, the imaging element 3 is a drum. In one example, the information indicative of the position of the imaging element 3 is information indicative of an angular position of the drum relative to the BID 4. The position of the imaging element 3 may be measured directly from the imaging element 3 or may be determined by measuring the position of a component of the system 2 remote from the imaging element 3. For example, as shown in FIG. 1, the transfer element 7 rotates in a counter direction 13 to the imaging element 3. The position of the imaging element 3 may be derivable from the position of the transfer element 7. As such, the position of the imaging element 3 may be determined by measuring the position of the transfer drum 7.

In the example shown in FIG. 1, an encoder 8 is provided to determine the information indicative of the position of the imaging element 3. As shown in FIG. 1, the encoder 8 may be provided in one of several positions. For example, the encoder 8 may be provided in communication with the imaging element 3, so as to directly measure the position of the imaging element 3, or in communication with the transfer element 7 so as to directly measure the position of the transfer element 7. In one example, the encoder 8 may be provided in communication with any component that allows the encoder 8 to determine information indicative of the position of the imaging element 3.

The printer 1 of FIG. 1 may include a print offset determining apparatus 9. The print offset determining apparatus 9 is to receive information indicative of the position of the imaging element 3 relative to the BID 4 when the BID 4 comes into contact with the imaging element 3, and to determine an offset between the position of the imaging element 3 and a reference position of the imaging element 3 relative to the BID 4. In the example of FIG. 1, the print offset determining apparatus 9 is shown separate to the controller 6. In one example, the print offset determining apparatus 9 may comprise the controller 6 or vice versa. For example, the print offset determining apparatus 9 and the controller 6 may comprise a unitary item.

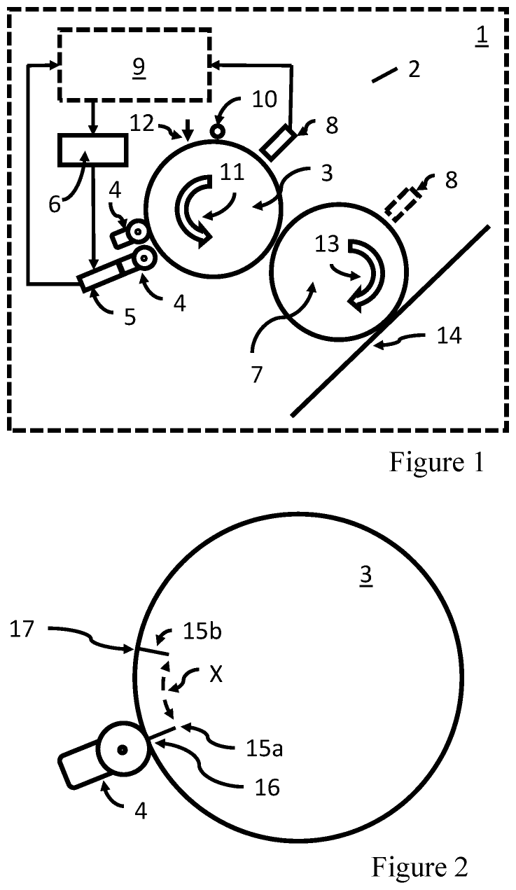

FIG. 2 shows a schematic diagram of the BID 4 in contact with the imaging element 3. As can be seen in FIG. 2, the BID 4 comes into contact with the imaging element 3 at a first point 16 on the imaging element corresponding to a first position 15a of the imaging element 3 relative to the BID 4. In one example, the BID 4 may be intended to come into contact with the imaging element 3 at a predetermined contact point 17 on the imaging element 3 in order to maintain synchronization between the BID 4 and the imaging element 3. The predetermined contact point 17 may correspond to a predetermined position (or reference position) 15b of the imaging element 3 relative to the BID 4. An offset X is a difference between the contact position 15a and the predetermined position 15b.

In one example, on the basis of the offset X, the print offset determining apparatus 9 is to generate a signal to control subsequent movement of the BID 4 relative to the imaging element 3. The signal may be a signal indicative of a time at which the BID 4 should begin to move relative to the imaging element 3 such that the BID 4 comes into contact with the imaging element 3 at substantially the predetermined contact point 17. As such, the signal is used to help synchronize movement of the BID 4 relative to the imaging element 3.

In one example, the print offset determining apparatus is to determine a correction factor on the basis of the offset X, and to generate the signal on the basis of the correction factor.

In one example, the print offset determining apparatus 9 is to output the signal to the controller 6 and the controller 6 is to determine a correction factor on the basis of the signal.

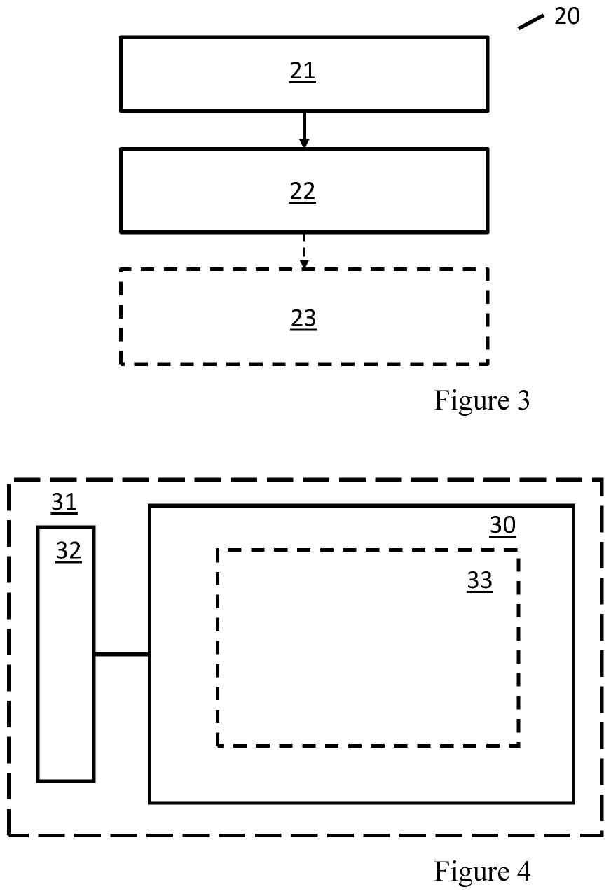

FIG. 3 shows a flow diagram of a method 20 according to one example. The method 20 may be performed by the controller 6 or the print offset determining apparatus 9, for example. The method 20 comprises: determining a position 21 of an imaging element 3 relative to a BID 4 when the BID 4 comes into contact with the imaging element 3; and determining a correction factor 22, to be used to control subsequent movement of the BID relative to the imaging element 3, on the basis of a difference between the position of the imaging element 3 and a predetermined position of the imaging element 3 relative to the BID 4.

In one example, the correction factor is determined such that, in the subsequent movement, the BID 4 comes into contact with the imaging element 3 at substantially the predetermined contact point 17.

As shown in FIG. 3, the method 20 may comprise determining that the BID 4 has come into contact with the imaging element 3 by determining a change in a property 23 of a driver 5 that is to drive movement of the BID 4 relative to the imaging element 3. The property may be one of those discussed elsewhere herein. For example, the property of the driver may be an electrical current.

In one example, an iterative process may be used to synchronize the position of the BID 4 with the imaging element 3 (i.e. such that the BID 4 comes into contact with the imaging element 3 at substantially the predetermined position 15b). The process may include: calculating a theoretical point of contact between the BID 4 and the imaging element 3; performing movement of the BID 4 towards the imaging element 3; determining a position of the imaging element 3 at a point in time when the BID 4 comes into contact with the imaging element 3; comparing the determined position to the theoretical point of contact between the BID 4 and the imaging element 3; and adjusting subsequent movement of the BID 4 relative to the imaging element 3 to account for the difference between the theoretical point of contact and the determined position.

FIG. 4 shows a schematic diagram of a non-transitory computer-readable storage medium 30 according to one example. The non-transitory computer-readable storage medium 30 stores instructions 33 that, if executed by a processor 32 of a controller 31, cause the processor 32 to perform one of the methods described herein. The instructions 33 may comprise instructions to perform any of the methods 20 described above with reference to FIG. 3. The processor 32 may be comprised in the controller 6 or the print offset determining apparatus 9, for example.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A print offset determining apparatus to:
receive information indicative of a position of an imaging element relative to a binary ink developer when the binary ink developer comes into contact with the imaging element; and
determine an offset between the position of the imaging element and a reference position of the imaging element relative to the binary ink developer.

2. The print offset determining apparatus of claim 1, wherein the apparatus is to, on the basis of the offset, generate a signal to control subsequent movement of the binary ink developer relative to the imaging element.

3. The print offset determining apparatus of claim 2, wherein the apparatus is to determine a correction factor on the basis of the offset, and to generate the signal on the basis of the correction factor.

4. A system comprising:
an imaging element;
a binary ink developer;
a driver operatively connected to the binary ink developer to drive the binary ink developer relative to the imaging element, and
a controller, the controller to:
determine information indicative of a position of the imaging element relative to the binary ink developer when the binary ink developer comes into contact with the imaging element; and
determine a correction factor for use in subsequent driving of the binary ink developer relative to the imaging element, the correction factor being based on the position of the imaging element and a reference position of the imaging element relative to the binary ink developer.

5. The system of claim 4, wherein the controller is to determine that the binary ink developer has come into contact with the imaging element by determining a change in a property of the driver.

6. The system of claim 5, wherein the property of the driver is an electrical current.

7. The system of claim 5, wherein the property of the driver is a torque.

8. The system of claim 4, wherein the imaging element is mounted for rotational movement relative to the binary ink developer, and the information indicative of the position of the imaging element is information indicative of an angular position of the imaging element.

9. The system of claim 4, comprising an encoder to determine the information indicative of the position of the imaging element.

10. A printer comprising the system of claim 4.

11. A method comprising:
determining a position of an imaging element relative to a binary ink developer when the binary ink developer comes into contact with the imaging element; and
determining a correction factor, to be used to control subsequent movement of the binary ink developer relative to the imaging element, on the basis of a difference between the position of the imaging element and a predetermined position of the imaging element relative to the binary ink developer.

12. The method of claim 11, wherein the correction factor is determined so that, in the subsequent movement, the binary ink developer comes into contact with the imaging element at substantially a predetermined contact point on the imaging element.

13. The method of claim 11, comprising determining that the binary ink developer has come into contact with the imaging element by determining a change in a property of a driver that is to drive movement of the binary ink developer relative to the imaging element.

14. The method of claim 13, wherein the property of the driver is an electrical current.

15. A non-transitory computer-readable storage medium comprising a set of computer-readable instructions stored thereon, which, when executed by a processor, cause the processor to carry out the method of claim 11.
